(19) United States
(12) Patent Application Publication
(10) Pub. No.: US 2006/0278349 A1
(43) Pub. Date: Dec. 14, 2006

(54) Space adjusting self centering end cap

(76) Inventor: Han-Sen Lee, Chang-Hwa Hsien (TW)

Correspondence Address: Curtis L. Harrington;Suite 250, 6300 State University Drive, Long Beach, CA, 90815, US

(21) Appl. No.: 11/153,079

(22) Filed: Jun. 14, 2005

(51) Int. Cl. E06B 9/00

(52) U.S. Cl. 160/178.1 R

(57) ABSTRACT

A specialized universal end cap is fittable into both ends of a conventional “U” shaped channel. The universal end cap preferably may have bilateral symmetry, a set of four edge projections for engaging both the lower two corners of the “U” shaped channel as well as the two upper located and downwardly curved top edge treatments for the channel. Further, one embodiment of the universal end cap contains swept protective edges to protect the user from burs which are more likely to occur on the parallel sides of the channel when it is cut. The main expanse of the universal end cap may contain one or more springing and force compressible projections which tend to automatically self-center the channel and take up any space or play between the ends of the capped channel and the widest point of the bracket. This mechanism not only provides self-centering but enables manufacturers to increase the next size differential to thereby decrease the number of sizes to be maintained, but without any significant reduction in quality, installability, or fit.

### FIELD OF THE INVENTION

The present invention relates to an improvement in providing a more customized window blind fit while minimizing injury potential in a horizontal blind head rail, providing a wider range of interfittability and self centering and more particularly to an end cap which provides both automatic space filling adjustment and centering in a universal manner.

### BACKGROUND OF THE INVENTION

Horizontal blind head rails typically fit into a window space by the use of brackets which preferably have doors which snap open and snap shut to admit and hold a head rail which supports a plurality of blinds. This “headrail” bracket is typically mounted within the window opening space and has a well supported width. In other applications it can be mounted outside the window space, but it is important that the brackets are rigidly mounted in order to both support and trap the ends of the horizontal blind head rail.

One of the objectives to be achieved in the field of window coverings and horizontal blinds in particular is the ability to avoid cutting the head rail to an exacting length to fit exactly within the brackets. This type of custom installation would involve, for an inside-the-window-opening installation, measuring the width available, subtracting the inside width of the two brackets, and then applying the distance to select the next closest, but longer horizontal blind set, and then sawing the head rail and louvers from each end to achieve the proper width.

The window opening is typically wider than the light transmissive area of the window, and the width of the louvers can, but often is not the dimension of greatest concern. The head rail is the main component of interest as it may be slightly wider than the width of the horizontal louvers, but will preferably be the same width. The brackets holding the head rail are typically from about one inch of lateral depth to about one half inch of lateral depth. As a result, any custom cut head rail will be easily secured where the head rail is not shorter than the lateral depth of one of the upper brackets.

Where the lateral width of the head rail is less than the width of the space available between the innermost, widest lateral space available to the headrail, the headrail can slide from side to side when operated. For example, louver lift control cords are typically operated by pulling down and to one side for release, or down and to the other side for lock. If there is excess clearance of the head rail within the brackets, the bracket can inadvertently shift to the left and right.

Inadvertent shifting can startle the user and cause the user to worry about the integrity of support of the horizontal blinds and head rail and can be annoying. Where the clearance space between the ends of the headrail and bracket is greater than the depth of one of the brackets, the headrail can slip out and fall, causing damage to a user, to the horizontal blinds set, and to the floor, furniture and other objects.

Another problem that headrail length and bracket dimension width match causes is the concomitant industry requirement to provide a larger array of sizes in order to insure that buyers can more precisely match the purchased horizontal blind set to the space which will be available within the innermost part of the brackets. Size differences of as little as one eighth of an inch are being required so that users can have no more than one eighth of an inch of play of the headrail within the bracket.

As by example, if this dimension differential between the next lower and next higher size could be increased by one third, the number of different sizes offered within the span of an inch would drop from eight to six. Providing an elongated, deep bracket is not the answer as this would simply increase the “play” of lateral shifting of the headrail within the bracket space and cause problems and annoyance, and longer brackets can produce more bending moment. Greater bending moment can put greater stress on mounting hardware which can cause the brackets and horizontal blind set to become dislodged. This is a particular problem because most window openings provide support only through drywall material. Most mounted brackets end up using the shear strength of screws or nails and cannot tolerate any significant bending moment.

For a given head rail of shorter dimension than the maximum width of the brackets, the shifting of the head rail in one direction or the other can produce maximum bending moment forces on the bracket in which the head rail is shifted away. Further shifting in the opposite direction will put maximum bending moment forces on the other bracket. Both brackets will become deleteriously affected.

Another problem with horizontal blind headrails is the provision of end caps. Most headrails are made in an overall “U” shape, possibly with the upper edges of the “U” turned down to make hooked sides. Each of the three sides of the “U” shaped channel is generally flat, and the ends of the headrail are most susceptible to bending. Further, conventional end caps have been known for insertion into the channel ends to help stabilize the channel ends. A left cap and a right cap are typically used, and inserted as a plug with some limiting protruding structure to both limit the extent of insertion into the channel and to control the dimension of the plug beyond the end of the channel.

However, conventional end caps have not contributed to the need to help control the channel's movement. Further such conventional plug-type end caps cannot handle any error or statistically occurring deviations in a cleanly cut end of the “U” shaped channel. Where a small portion of the channel, such as a bur or bend, extends inwardly, the conventional plug will be blocked. Workers have to then try to spend extra time either removing the burr or bending it out of the way.

Where a burr extends outwardly, or where the end of the “U” channel is roughly cut, workers can be injured simply from handling the channel. Outwardly extending rough edges can continue to injure workers who assemble the channels as well as installers who handle the horizontal blind sets. Conventional end caps are right-end and left-end specific and do not provide any additional protection from burrs, bends, and sharp edges.

What is therefore needed is a system which increases structural stability of headrails while poviding protection against sharp edges of a headrail channel, and which enables a lesser number of different size headrails to be utilized while providing for a more exacting fit for installers of horizontal blinds.

### SUMMARY OF THE INVENTION

A specialized universal end cap fits into both ends of a conventional “U” shaped channel. The universal end cap preferably may have bilateral symmetry, a set of four edge projections for engaging both the lower two corners of the “U” shaped channel as well as the two upper located and downwardly curved top edge treatments for the channel. Further, one embodiment of the universal end cap contains swept protective edges to protect the user from burs which are more likely to occur on the parallel sides of the channel when it is cut. The main expanse of the universal end cap may contain one or more springing and force compressible projections which tend to automatically self-center the channel and take up any space or play between the ends of the capped channel and the widest point of the bracket. This mechanism not only provides self-centering but enables manufacturers to increase the next size differential to thereby decrease the number of sizes to be maintained, but without any significant reduction in quality, installability, or fit.

A wide variety of flexible, springing topologies can be used ranging from structures which extend from the cap outer surface, structures which form part of the surface, and structures which extend from a point below the surface. In a first embodiment, at least one structure extends at an angle from the outside surface and is springingly bent or compressed. This embodiment is utilized to introduce other structures which can be included in any of the embodiments, and include supported bearing corners and wrapped side edges to cover and provide a smooth exterior over any rough edges.

### BRIEF DESCRIPTION OF THE DRAWINGS

The invention, its configuration, construction, and operation will be best further described in the following detailed description, taken in conjunction with the accompanying drawings in which:

FIG. 1 is a plan view of the outside or first surface of a first embodiment of a universal end cap and illustrating a pair of opposed curving projections;

FIG. 2 is a plan view of an inside surface or second surface of the first embodiment of a universal end cap seen in FIG. 1;

FIG. 3 is a side view of the universal end cap seen in FIGS. 1-2 and illustrating the depth and shaped ends of the securing projections;

FIG. 4 illustrates an alternative embodiment of the inside surface or second surface of the first embodiment of a universal end cap seen in FIG. 1;

FIG. 5 is a plan view of the outside or first surface of a third embodiment of a universal end cap and illustrating a pair of opposed curving projections which operate by a cut in the material between the first and second surfaces of the main extent of the universal end cap;

FIG. 6 is a side view of the universal end cap seen in FIG. 5 and illustrating one example of the height and curvature of opposed spring urged flaps;

FIG. 7 is a plan view of the outside or first surface of a fourth embodiment of a universal end cap and illustrating a single curving projection which operates by a cut in the material between the first and second surfaces of the main extent of the universal end cap;

FIG. 8 is a side view of the universal end cap seen in FIG. 7 and illustrating one example of the height and curvature of the single urged flap;

FIG. 9 is a semi-sectional side view showing a non sectional view of the portions of the cap on the attachment side of the first surface and a sectional view of serpentine mounted planar members which function to compress to provide self centering and lateral dimension adjustment and which also provide quick removability for overall lateral dimension adjustment;

FIG. 10 illustrates the end cap of FIG. 9 shown in a compressed configuration;

FIG. 11 illustrates a portion of the end cap of FIG. 9 shown as being broken away for permanent removal to reduce the overall dimension of the structures of the end cap of FIGS. 9 and 10, especially under full compression;

FIG. 12 is a perspective view of the end cap of FIGS. 1-3 shown in mounting position with respect to a “U” shaped channel as is typically associated with a horizontal blind assembly.

### DETAILED DESCRIPTION OF THE PREFERRED EMBODIMENT

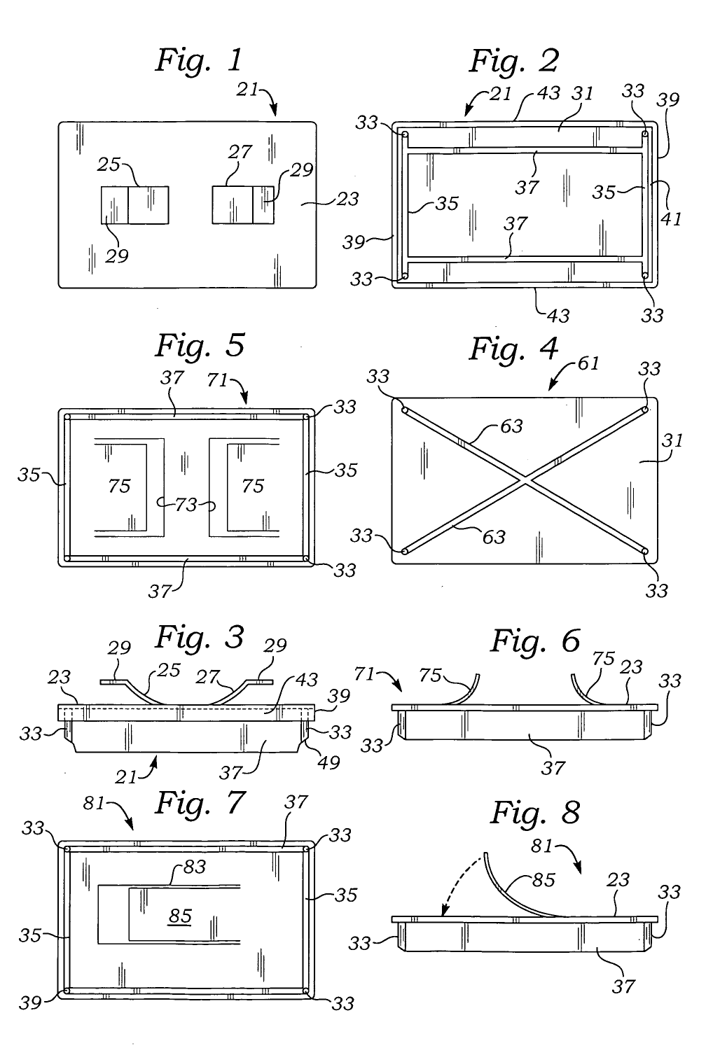

The description and operation of the shutter system of the invention will be best described with reference to FIG. 1 which illustrates a plan view of the outside of a universal end cap 21 which would fit into a “U” shaped channel of a head rail of a horizontal blind set. Universal end cap 21 provides structural stability, protection, and a dimensional extension adjustability to mitigate the need to perform more finely quantized size availability in order to provide a more exacting fit for installers of horizontal blinds.

A first surface 23 is located at a first side. First surface 23 is an exterior outer surface and generally smooth. The outer periphery of the universal end cap 21 is generally at least dimensionally equal to or greater than the dimensional extent of the end of the channel (not shown). A pair of curving projections 25 and 27 are seen. From the center of the end cap 21, the two structures rise curvingly from the exterior surface 23 and to a flattened super surface extent 29. Note that universal end cap 21 has bilateral symmetry.

Referring to FIG. 2, the universal end cap 21 has a generally planar second surface 31 at a second side. Between the first surface 23 and second surface 31, a thickness of material exists. The thickness of the material will depend somewhat upon choice and somewhat upon the bendability and flexibility of structures which will be used to be compressed to provide the ability to fit within a variable space. In the alternative, a segregable material can be used, where the user can break off portions of the end cap 21, 61, or 71 to achieve a fit.

From the generally planar second surface 31 a number of structures rise up. Located near the four corners of universal end cap 21, a series of four projections 33 extend toward the viewer with respect to FIG. 2. The projections 33 will typically fit into a channel's corners at the adjacent junction between its walls. A four walled square channel will have four corners and will thus utilize all four projections. A “U” shaped channel will typically utilize two of the projections in the lower two corners between a base wall and side walls.

To make the four projections easier to fit within the “U” shaped channel, the distal most portion with respect to the second surface 31 may have a slanted end surface, typically as an end cut slanted down and away from the center of the universal end cap 21, or from a common plane in order to facilitate the insertion of the universal end cap 21 into a “U” shaped channel (not shown). Even the two upper projections 33 are expected to give some lateral stability with respect to the side walls of a channel having an open upper extent.

The rear side of universal end cap 21 shown in FIG. 2 also has bilateral symmetry. For a given size of “U” shaped channel, two of the projections 33 rest at the bend between the channel side walls and floor, while the opposite two projections 33 reside within the upper curled or curved over edges of the channel. Thus the projections 33 are expected to be compressed towards each other. Standing alone, the size of the projections 33 might be such that they could be sheared off upon insertion or bent. Therefore one out of possibly hundreds of structural reinforcements abut and are preferably part of the projections 33.

At either side of the universal end cap 21 a raised wall 35 extends between and actually may preferably form a part of or be continuous with the projections 33. Each of the raised walls 35 extending between the projections 33 may be met by an intersecting raised wall 37. The arrangement shown gives the projections 33 a stronger support in the direction of the shorter length of the universal end cap 21 so insure that the projections push against the top and bottom of the channel (not shown). The position of connection of the intersecting raised wall 37 indicates tat some greater flexibility is to be given for some displacement of the projections 33 in the direction of the longer dimension of the universal end cap 21 seen in FIG. 2. Other alternatives are possible.

Also seen in FIG. 2 are a pair of raised protective side walls 39 which are raised and displaced from the projections 33 so as to define a small capture channel 41 between the projections 33 and protective side wall 39. Viewed from the side when the universal end cap 21 is attached to a channel, the protective side wall 39 will be seen to slightly wrap around an end edge of the channel to protect the user's hand and to cover any rough portion or burrs on the channel. Likewise, a pair of raised protective side walls 43 which are raised and displaced from the projections 33 so as to define a wider capture area 45 between the projections 33 and intersecting raised wall 37 and the raised protective side wall 43.

None of the walls 39 and 43 are absolutely necessary and do add more complexity to the shape of the universal end cap 21. Walls 39 and 42 simply form an annular path for an edge of a head rail to be more fully enclosed, to reduce harm from any burs inadvertently left behind.

Referring to FIG. 3, a side view illustrates more clearly the structures seen in FIGS. 1 and 2. On the outer or first surface 23, pair of curving projections 25 and 27 can be seen more clearly leading to flattened upper surface extents 29. When universal end cap 21 is used, an amount of additional dimension in the direction of the head rail is added in accord with the distance of which the upper surface extents 29 rise above the first surface 23. When a bracket presses against the upper surface extents 29, the pair of curving projections 25 and 27 begin to bend straight and the upper surface extents 29 press flat against the first surface 23.

The embodiment of FIGS. 1-3 emphasize a structure rising from a first surface 23 while taking up none of the space below surface 23. This type of configuration enables and facilitates the use of a wide variety of structures above the first surface 23 which can compress to facilitate self centering and the accommodation of a completed channel and universal end cap assembly to permit a shorter headrail channel to fit within a larger space than it otherwise should fit. The compressible structure need not be limited to the pair of curving projections 25 and 27, but may include any number of structures such as are convenient. The area below the first surface 23 is free to have any form of placement of other structures such as the walls 35 and 37.

Further, FIG. 3 illustrates that the tip ends of the projections 33 can have end surfaces 49 which are not centered or which have angled flats in order to guide the universal end cap 21. The depth of the universal end cap 21 should be deep enough for a good fit, but not deep enough to interfere with any structures within the head rail or channel.

Referring to FIG. 4, an alternative embodiment is shown as a universal end cap 61 in which the protective side walls 33 and 39 have been removed from its generally planar second surface 31. Instead of the raised walls 35 and 37 have a change of orientation to an “X” structure as four center directed walls 63. The “X” structure, and others like it, can occupy the area at the center of the generally planar second surface 31.

Referring to FIG. 5, a third embodiment is seen as a universal end cap 71, and in which the raised walls 37 and 35 have been moved almost to the square peripheral extent of the four projections 33. This results in an expanded, unobstructed area for generally planar second surface 31. However, the generally planar second surface 31 is interrupted by a series of cutouts 73, with the areas surrounding the cutout being stressed away from generally planar second surface 31 and above first surface 23. The pre-stressing can be accomplished by molding the universal end cap 71 in a configuration where the components are pre-formed, or the orientation can be formed by heat or bending stress or both.

The cutouts 73 define a pair of flaps 75. The side dimension of the cutouts 73 are exaggerated for purposes of understanding, but the clearance between the flaps 75 and the surrounding material may have a clearance which is minimum and which will allow the flap 75 to fit back to an even level with respect to the surrounding material.

Referring to FIG. 6, a side view of universal end cap 71 is seen with the flaps 75 shown as curved upward as seen in FIG. 5. The upward curvature is responsible for the even more exaggerated clearance seen for slot 73 along the center of the universal end cap 71, when taken from a plan perspective. And as can be seen in FIG. 6, the flaps 75 can compress under pressure. The important aspect of universal end cap 71 is that the portions of the universal end cap 71 material which can be compressed under pressure can compress in a way that enables the range of effective dimensional variability ranges from the height of the upper tip edge of the flaps 75 seen in FIG. 6 to the first surface 23.

Any dimension of the flaps 75 which are still curved can reside within the boundary of the generally planar second surface 31. Even though FIG. 6 only illustrates a curvature of material which may preferably be made from the same material of the universal end cap 71, the type and thickness of material may somewhat dictate the shape and overall structure of the flaps 75.

Aside from the fact that the structure of FIGS. 1-3 is compressed ultimately from and against the first surface 23 and that the structure of FIGS. 5 and 6 enable the applicable structures to be springingly urged through the first surface 23, the displacement-compression function of any structure used with the universal end caps 21, 61, and 71 is permitted within the scope of the invention. Further, FIGS. 1-6 illustrate a folding or bending moment about one point or plane, and it is contemplated that other more complex mechanisms can be utilized.

Referring to FIG. 7, a fourth embodiment is seen as a universal end cap 81, and in which, again, the raised walls 37 and 35 have been moved almost to the square peripheral extent of the four projections 33 and results in an expanded, unobstructed area for generally planar second surface 31. The generally planar second surface 31 is interrupted by only a single cutout 83 which forms a single large flap 85. The areas surrounding the cutout 83 being stressed away from generally planar second surface 31 and above first surface 23. The pre-stressing can be accomplished by molding the universal end cap 81 in a configuration where the components are pre-formed, or the orientation can be formed by heat or bending stress or both.

Referring to FIG. 8, a side view of universal end cap 81 is seen with the flap 85 shown in a position curved upward as seen in FIG. 5. The upward curvature is responsible for the even more exaggerated clearance seen for a portion of the cutout 83 along the center of the universal end cap 81, when taken from a plan perspective. And as can be seen in FIG. 8 by the indicated arrow, the flap 85 can bendably move toward the universal end cap first surface 23 under applied force. The universal end cap 81 material can be bendably compressed in a way that enables the range of effective dimensional variability ranges from the height of the upper tip edge of the flap 85.

Any dimension of the flaps 85 which are still curved can reside within the boundary of the generally planar second surface 31. Even though FIG. 8 only illustrates a curvature of material which may preferably be made from the same material of the universal end cap 81, the type and thickness of material may somewhat dictate the shape and overall structure of the flap 85. Further, the flap 85 can be tapered where it is desired to control its shape and form as it bends.

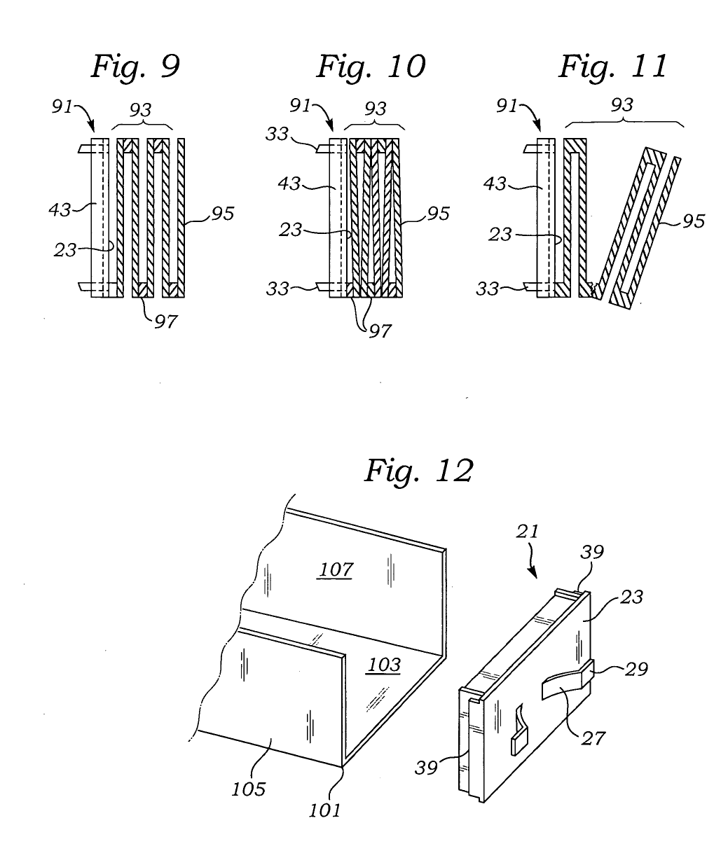

Another, possibly more complex mechanism is seen in FIG. 9 in cross sectional view. A universal end cap 91 has a zig-zag or serpentine compressible structure 93 is added to extend from the first surface 23. The compressible structure is capable of both adding variable effective length to a horizontal blind head-rail, as well as decreasing the minimum effective width of the head rail and end cap 91 dimension by breakable removal of one or more of a series of planar members 95. The planar members 95 may have connecting portions 97 which may extend only partially or fully laterally across the planar member 95. The brevity of extension will facilitate manual breaking away of the portion of the stack of planar members 95 not needed.

Referring to FIG. 10, compression of the planar members 95 is shown. Referring to FIG. 11, a number of the planar members 95 have been pulled away to form a more abbreviated width end cap 91. Thus, with the configuration of FIGS. 9-11, an end cap 91 can be provided which can be compressed to fit within brackets and then have a number of its planar members 95 removed, preferably an equal number from each side, to provide a shorter effective width structure, while still achieving self centering.

Referring to FIG. 12, a short section of “U” shaped channel 101 such as may be utilized with any of the universal end caps 21, 61, 71, 81 or 91 described herein, but is shown with respect to universal end cap 21. The “U” shaped channel 101 has a base wall 103 and side walls 105 and 107. The universal end cap 21 is shown as having protective side walls 39 but no protective sidewalls 43. In this configuration, the end edges of the side walls 105 and 107 will be protected with the end edge of the base wall 103 being only partially protected by its edge being partially covered by the lower edge of the universal end cap 21.

It can be noted that the universal end cap 21 can be rotated within the plane of the first surface 23, turned 180 degrees and would still fit. This means that the same design of universal end cap 21 and end caps 61, 71, 81 or 91 can each fit on either end of the “U” shaped channel 101. This means that the number of end caps carried need only be half of the number of conventional plug-type channel members which are specifically left and right hand plugs.

While the present invention has been described in terms of an end cap system which provides (1) structural stability, (2) protection against sharp edges of a headrail channel, (3) a dimensional extension adjustability to mitigate the need to perform more finely quantitized size availability in order to provide a more exacting fit for installers of horizontal blinds, and (4) self centering, one skilled in the art will realize that the structure and techniques of the present invention can be applied to many structures, including any structure where the above goals can be achieved by the above goals in an interfitting addition.

Although the invention has been derived with reference to particular illustrative embodiments thereof, many changes and modifications of the invention may become apparent to those skilled in the art without departing from the spirit and scope of the invention. Therefore, included within the patent warranted hereon are all such changes and modifications as may reasonably and properly be included within the scope of this contribution to the art.

What is claimed:

1. A universal end cap comprising:
a planar main extent having a first side and a second side, said second side having at least one projection for facilitating placement of said end cap within a channel, said first side having a structure extending from said first side for projecting an extension of an effective dimension beyond said first side and force compressible in a direction toward said first side.

2. The universal end cap as recited in claim 1 wherein said structure extending from said first side of said planar main extent is a curved structure extending from a first surface of said first side of said planar main extent.

3. The universal end cap as recited in claim 1 wherein said structure extending from said first side of said planar main extent is a curved structure formed by a part of said planar main extent.

4. The universal end cap as recited in claim 1 wherein said structure extending from said first side of said planar main extent is a serpentine compressible structure.

5. The universal end cap as recited in claim 1 wherein said structure extending from said first side of said planar main extent is a flap adjacent a cutout in said planar main extent, into which said flap may enter upon forced displacement.

6. The universal end cap as recited in claim 5 wherein said flap is a plurality of flaps, each with its own cutout.

7. The universal end cap as recited in claim 6 wherein said flaps oppose each other.

8. The universal end cap as recited in claim 1 wherein said main planar extent supports a protective side wall for partially encasing an edge of a channel on at least an end edge and an exterior side.

9. The universal end cap as recited in claim 1 wherein said at least one projection of said second side is supported by a raised wall.

10. The universal end cap as recited in claim 1 wherein said at least one projection are at least a plurality of projections and supported by a raised wall.

11. The universal end cap as recited in claim 9 wherein said at least one projection forms a portion of said raised wall.

12. The universal end cap as recited in claim 1 wherein said at least one projection is a raised wall.

13. The universal end cap as recited in claim 11 wherein said raised wall extends adjacent a periphery of said second side.

14. The universal end cap as recited in claim 1 wherein said at least one projection has a slanted end surface to facilitate insertion of said universal end cap into a channel.

15. The universal end cap as recited in claim 1 wherein said at least one projection is a plurality of projections each of which is configured to securely fit into a corner adjacent two side walls of a channel.
